(19) United States
(12) Patent Application Publication
(10) Pub. No.: US 2005/0141725 A1
(43) Pub. Date: Jun. 30, 2005

(54) Apparatus for correcting sound for video display appliance and method thereof

(75) Inventor: Hee Jin Kim, Buk-gu (KR)

Correspondence Address: FLESHNER & KIM, LLP, P.O. BOX 221200, CHANTILLY, VA, 20153, US

(73) Assignee: LG Electronics Inc.

(21) Appl. No.: 11/023,626

(22) Filed: Dec. 29, 2004

(30) Foreign Application Priority Data
Dec. 30, 2003 (KR) 10-2003-99899

(51) Int. Cl. H04R 29/00

(52) U.S. Cl. 381/58; 381/302; 381/99

(57) ABSTRACT

Disclosed is an apparatus for correcting sound for a video display appliance and a method thereof that senses the change of the sound characteristics of the video display appliance and performs an automatic sound correction according to the change of the sound characteristics. The apparatus includes a key input unit for inputting a user's command, a sound sensing unit for sensing bass/middle/treble ranges of sound output through the speaker, a memory for storing reference sound levels of the bass/middle/treble ranges of the sound preset according to installation environment characteristics of the video display appliance, and a control unit for comparing the sound levels of the bass/middle/treble ranges of the sound sensed through the sound sensing unit with the reference sound levels of the bass/middle/treble ranges of the sound, correcting sound characteristics according to a result of comparison, and feeding the corrected sound characteristics back to the audio signal processing unit.

### BACKGROUND OF THE INVENTION

1. Field of the Invention

The present invention relates generally to a video display appliance, and more particularly to an apparatus for correcting sound for a video display appliance and a method thereof that performs a sound correction according to the characteristics of sound fed back from the video display appliance.

2. Description of the Related Art

Generally, video display appliances are installed in diverse environments, and thus their sound characteristics may diversely be changed accordingly. That is, even if the sound characteristic of a video display appliance was well set when the video display appliance was designed, it may be changed in accordance with the change of its use environment or installation condition.

FIG. 1 is a block diagram illustrating the construction of a conventional video display appliance, and FIG. 2 is a flowchart illustrating a sound correcting method for the conventional video display appliance.

The conventional video display appliance, as illustrated in FIG. 1, includes a tuner 11 for selecting a broadcasting signal received through an antenna, a DeMUX (Demultiplexer) 12 for separating the broadcasting signal received through the tuner 11 into video signal, audio signal and additional information, a video signal processing unit 13 for receiving and processing the video signal separated through the DeMUX 12 to display the processed video signal through a display unit 14, an audio signal processing unit 15 for receiving and processing the audio signal separated through the DeMUX 12 to output the processed audio signal through a speaker 16, a key input unit 17 for inputting a user's command, a memory 18 for storing various kinds of operation-related menus, and a control unit 19 for outputting a control 9 signal according to the user's command input through the key input unit 17.

According to the conventional video display appliance as constructed above, if a user selects a desired channel through the tuner 11 after the user inputs a ‘power-on’ command through the key input unit 17, a broadcasting signal received through the channel selected by the user is input to the DeMUX 12 and separated into video signal, audio signal and additional information through the DeMUX 12.

The video signal separated through the DeMUX 12 is processed by the video signal processing unit 13, and then displayed through the display unit 14. Meanwhile, the audio signal separated through the DeMUX 12 is processed by the audio signal processing unit 15, and then output through the speaker 16 as sound.

The sound correcting method for the conventional video display appliance will be explained with reference to FIG. 2.

If the user inputs the ‘power-on’ command, the received broadcasting signal is separated into the video signal, audio signal and additional information, and the video signal and the audio signal are processed and output as image and sound, respectively (steps S11 and S12).

In this state, if the user desires the change of sound volume, the user may change the sound volume on a sound volume change menu (steps S13 and S14).

If a ‘power-off’ command is input in this state, the operation of the video display appliance is terminated (step S15).

The conventional video display appliance as described above, however, is not provided with any function for automatically performing a proper sound correction with respect to the sound characteristic that is changed according to the installation environment of the video display appliance. Accordingly, the sound is reproduced in a state that the sound characteristic set when the video display appliance was designed is maintained as it is, and this may cause the sound of a specified band to be improperly amplified and output through the speaker 16 according to the installation environment of the video display appliance. The sound output as above is liable to have distorted band characteristics, and this may cause the user to feel awkward in listening to the sound or to be displeased with the sound.

In this case, the user may display a menu for correcting the sound characteristic on the display screen through the key input unit 17, and adjust the sound characteristic to a desired state though the menu. However, it is difficult and inconvenient for the user to do such adjustment.

The distortion of the sound characteristic as described above mostly occurs in the band of bass. The smaller the installation space of the video display appliance is and the more reflecting objects exist around the video display appliance, the greater the bass is amplified. This causes an output human voice to be unclear, and the clarity of sound deteriorates.

If the user reduces the sound volume to overcome the above-described problem, this merely causes the reduction of the whole sound strength, but the problems caused by the excessively amplified bass sound is not solved.

Because the user cannot accurately know how to adjust in order to solve the problems caused by the excessively amplified bass sound, it is still difficult for the user to listen to the output sound the characteristic of which is properly set.

### SUMMARY OF THE INVENTION

The present invention is directed to an apparatus for correcting sound for a video display appliance and a method thereof that substantially obviate one or more problems due to limitations and disadvantages of the related art.

It is an object of the present invention to provide an apparatus for correcting sound for a video display appliance and a method thereof that senses the change of the sound characteristics of the video display appliance and performs an automatic sound correction according to the change of the sound characteristics.

To achieve this and other objects and advantages in accordance with the purpose of the present invention, as embodied and broadly described herein, there is provided an apparatus for correcting sound for a video display appliance having a tuner for selecting a broadcasting signal, a demultiplexer for separating the received broadcasting signal into video and audio signals and a speaker for outputting the sound, which comprises a key input unit for inputting a user's command, a sound sensing unit for sensing bass/middle/treble ranges of sound output through the speaker if a ‘power-on’ command is input through the key input unit, a memory for storing reference sound levels of the bass/middle/treble ranges of the sound preset according to installation environment characteristics of the video display appliance, and a control unit for comparing the sound levels of the bass/middle/treble ranges of the sound sensed through the sound sensing unit with the reference sound levels of the bass/middle/treble ranges of the sound, correcting sound characteristics according to a result of comparison, and feeding the corrected sound characteristics back to the audio signal processing unit.

Preferably, the sound sensing unit comprises a microphone.

Preferably, the sound sensing unit is installed on a specified position of a front of the video display appliance.

Preferably, the sound sensing unit measures the sound levels of the bass/middle/treble ranges of the sound that are output through the speaker, reflected according to the installation environment characteristics of the video display appliance, and then input to the sound sensing unit.

Preferably, the control unit calculates a sound difference value between the sensed sound levels of the middle/bass ranges, and if the calculated sound difference value is not equal to a preset reference value, corrects the sound characteristics of the middle/bass ranges so that the sound difference value becomes equal to the preset reference value. Additionally, the control unit calculates a sound difference value between the sensed sound levels of the middle/treble ranges, and if the calculated sound difference value is not equal to a preset reference value, corrects the sound characteristics of the middle/treble ranges so that the sound difference value becomes equal to the preset reference value.

In another aspect of the present invention, there is provided an apparatus for correcting sound for a video display appliance having a speaker for outputting the sound, which comprises a memory for storing reference values of sound differences between sound levels of middle/bass ranges of the sound and reference values of sound differences between sound levels of middle/treble ranges of the sound among the sound levels of the bass/middle/treble ranges of the sound preset according to installation environment characteristics of the video display appliance, a sound sensing unit for sensing bass/middle/treble ranges of the sound output through the speaker, and a control unit for calculating a sound difference value between the sound levels of the middle/bass ranges among the sound levels of the bass/middle/treble ranges of the sound sensed through the sound sensing unit, and if the calculated sound difference value is not equal to the preset reference value of the sound difference between the sound levels of the middle/bass ranges of the sound, correcting the sound characteristics of the middle/bass ranges so that the sound difference value between the sound levels of the middle/bass ranges becomes equal to the preset reference value, the control unit further calculating a sound difference value between the sound levels of the middle/treble ranges among the sound levels of the bass/middle/treble ranges of the sound, and if the calculated sound difference value is not equal to the preset reference value of the sound difference between the sound levels of the middle/treble ranges of the sound, correcting the sound characteristics of the middle/treble ranges so that the sound difference value between the sound levels of the middle/treble ranges becomes equal to the preset reference value.

Preferably, the sound sensing unit comprises a microphone.

Preferably, the sound sensing unit is installed on a specified position of a front of the video display appliance.

Preferably, the sound sensing unit measures the sound levels of the bass/middle/treble ranges of the sound that are output through the speaker, reflected according to the installation environment characteristics of the video display appliance, and then input to the sound sensing unit.

In still another aspect of the present invention, there is provided a method for correcting sound for a video display appliance having a tuner for selecting a broadcasting signal, a demultiplexer for separating the received broadcasting signal into video and audio signals and a speaker for outputting the sound, which comprises the steps of reproducing and outputting through the speaker bass/middle/treble range of the audio signal separated through the demultiplexer if a user inputs a ‘power-on’ command, sensing the bass/middle/treble ranges of the sound output through the speaker, and comparing sound levels of the sensed bass/middle/treble ranges of the sound with reference sound levels of the bass/middle/treble ranges of the sound stored in a memory and correcting sound characteristics of the output sound according to a result of comparison.

Preferably, the sound sensing step senses the sound input through a microphone.

Preferably, the microphone is installed on a specified position of a front of the video display appliance.

Preferably, the sound sensing step measures the sound levels of the bass/middle/treble ranges of the sound that are output through the speaker, reflected according to the installation environment characteristics of the video display appliance, and then input to the sound sensing unit.

Preferably, the step of correcting the sound characteristics comprises the sub-steps of calculating a sound difference value between the sensed sound levels of the middle/bass ranges, if the calculated sound difference value is not equal to a preset reference value, correcting the sound characteristics of the middle/bass ranges so that the sound difference value becomes equal to the preset reference value, calculating a sound difference value between the sensed sound levels of the middle/treble ranges, and if the calculated sound difference value is not equal to a preset reference value, correcting the sound characteristics of the middle/treble ranges so that the sound difference value becomes equal to the preset reference value.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating the construction of a conventional video display appliance;

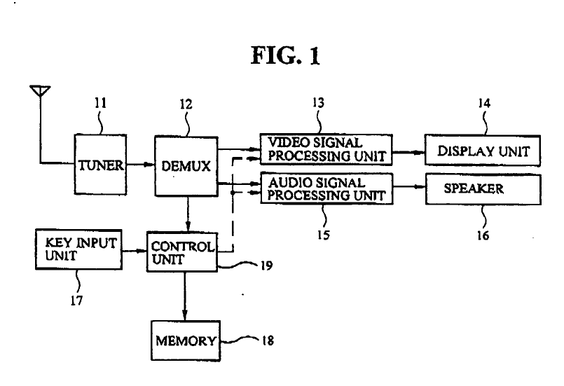

FIG. 2 is a flowchart illustrating a sound correcting method for the conventional video display appliance;

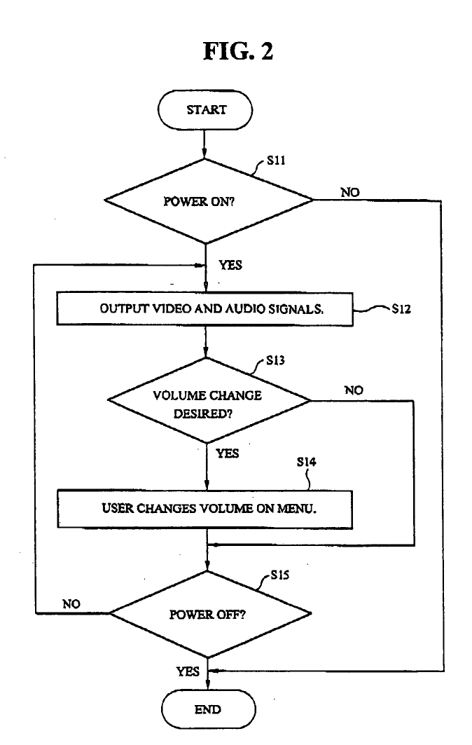

FIG. 3 is a block diagram illustrating the construction of a sound correcting apparatus for a video display appliance according to the present invention; and

FIG. 4 is a flowchart illustrating a sound correcting method for a video display appliance according to the present invention.

### DETAILED DESCRIPTION OF THE PREFERRED EMBODIMENT

Reference will now be made in detail to the preferred embodiment of the present invention, examples of which are illustrated in the accompanying drawings. Wherever possible, the same reference numbers will be used throughout the drawings to refer to the same or similar parts.

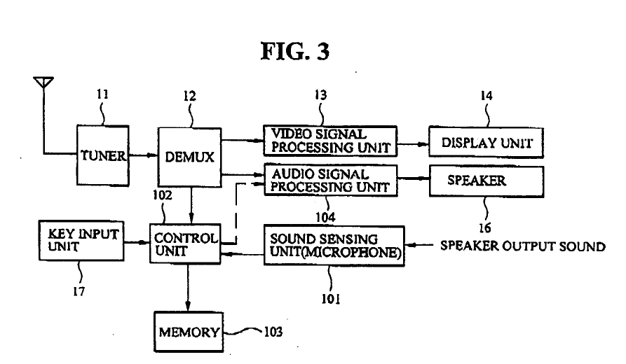

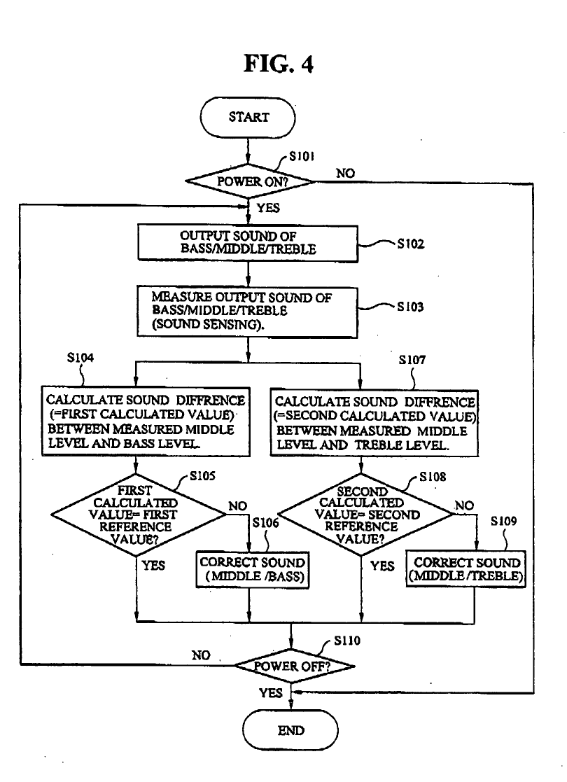

FIG. 3 is a block diagram illustrating the construction of a sound correcting apparatus for a video display appliance according to the present invention, and FIG. 4 is a flowchart illustrating a sound correcting method for a video display appliance according to the present invention.

The sound correcting apparatus for a video display appliance, as illustrated in FIG. 3, includes a tuner 11 for selecting a channel broadcasting signal desired by a user among broadcasting signals received through an antenna, a DeMUX 12 for separating the channel broadcasting signal selected through the tuner 11 into video signal, audio signal and additional information, a video signal processing unit 13 for receiving and processing the video signal input from the DeMUX 12 to display the processed video signal through a display unit 14, a key input unit 17 for inputting a user's command, an audio signal processing unit 104 for receiving and processing the audio signal input from the DeMUX 12 to output the processed audio signal through a speaker 16, a sound sensing unit 101 for sensing bass/middle/treble ranges of the sound output through the speaker and then reflected according to installation environment characteristics of the video display appliance, a memory 103 for storing reference sound levels of the bass/middle/treble ranges of the sound preset according to the installation environment characteristics of the video display appliance, and a control unit 102 for outputting a control signal according to the user's command input through the key input unit 17, comparing the sound levels of the bass/middle/treble ranges of the sound sensed through the sound sensing unit 101 with the reference sound levels of the bass/middle/treble ranges of the sound stored in the memory 103, and correcting sound characteristics of the output sound according to a result of comparison to feed the corrected sound characteristics back to the audio signal processing unit 104.

Here, the sound sensing unit 101 comprises a microphone, and is installed on a specified position of a front of the video display appliance.

The operation of the sound correcting apparatus for a video display appliance as constructed above will now be explained.

If the user selects a desired channel through the tuner 11 after the user inputs a ‘power-on’ command through the key input unit 17, a broadcasting signal received through the channel selected by the user is input to the DeMUX 12. The broadcasting signal input to the DeMUX 12 is separated into video signal, audio signal and additional information.

The video signal separated through the DeMUX 12 is processed by the video signal processing unit 13, and then displayed through the display unit 14. Meanwhile, the audio signal separated through the DeMUX 12 is processed by the audio signal processing unit 104, and then output through the speaker 16 as sound.

The sound output through the speaker is sensed through the sound sensing unit 101, and the sound characteristics of the sensed sound are measured. The measured sound characteristics are input to the control unit 102, and compared with the reference sound characteristic levels pre-stored in the memory 103 to correct the sound characteristics.

Accordingly, even if the user does not directly correct the sound characteristics, the sound is reproduced to most suitably meet the installation environment characteristics of the video display appliance.

Hereinafter, the sound correcting method for a video display appliance according to the present invention will be explained with reference to FIG. 4.

If the user inputs the ‘power-on’ command, the bass/middle/treble ranges of the sound are processed through the audio signal processing unit 104, and then output to the speaker 16 (steps S101-S102).

The bass/middle/treble ranges of the sound, which are output through the speaker and reflected according to the installation environment characteristics of the video display appliance, are sensed by the sound sensing unit 101 (step S103).

Then, a first calculated value that is a sound difference value between the sensed sound levels of the middle/bass ranges is calculated (step S104), and then it is judged whether the first calculated value is equal to a first preset reference value (step S105).

If the first calculated value is not equal to the first reference value as a result of judgment at step S105, the sound characteristics of the middle/bass ranges are corrected so that the sound difference value becomes equal to the first reference value (step S106).

Additionally, a second calculated value that is a sound difference value between the sensed sound levels of the middle/treble ranges is calculated (step S107).

Then, it is judged whether the second calculated value is equal to a second preset reference value (step S108).

If the second calculated value is not equal to the second reference value as a result of judgment at step S108, the sound characteristics of the middle/treble ranges are corrected so that the sound difference value becomes equal to the second reference value (step S109).

As described above, according to the sound correcting apparatus and method for a video display appliance according to the present invention, the sound characteristics of the output sound that match the sound balance suitable for the human ears are measured through the sound sensing unit 101 installed on the front of the video display appliance, and stored in the memory 103 as the reference values of the bass/middle/treble ranges of the sound.

The bass/middle/treble ranges of the sound that are output from the speaker and then reflected by the reflecting objects existing around the video display appliance are sensed by the sound sensing unit 101, and then compared with the reference values stored in the memory 103, and the bass/middle/treble ranges of the sound are automatically corrected according to the result of comparison.

Accordingly, the sound correcting apparatus and method for a video display appliance according to the present invention has the following effects.

First, because the sound output through the speaker of the video display appliance is automatically corrected in accordance with the change of the sound characteristics of the reflected sound in the installation space of the video display appliance, the sound can be reproduced under the condition of the optimum sound characteristic without the necessity of the user's manual correction work.

Second, because the sound is reproduced under the optimum sound characteristic, the clarity of the sound can be maintained.

Third, by preventing the bass sound from being excessively amplified, the howling of the sound caused by the excessively amplified bass sound in the installation space can be prevented in advance.

The forgoing embodiments are merely exemplary and are not to be construed as limiting the present invention. The present teachings can be readily applied to other types of apparatuses. The description of the present invention is intended to bc illustrative, and not to limit the scope of the claims. Many alternatives, modifications, and variations will be apparent to those skilled in the art.

1. An apparatus for correcting sound for a video display appliance having a tuner for selecting a broadcasting signal, a demultiplexer for separating the received broadcasting signal into video and audio signals and a speaker for outputting the sound, the apparatus comprising:
a key input unit for inputting a user's command;
a sound sensing unit for sensing bass/middle/treble ranges of sound output through the speaker if a ‘power-on’ command is input through the key input unit;
a memory for storing reference sound levels of the bass/middle/treble ranges of the sound preset according to installation environment characteristics of the video display appliance; and
a control unit for comparing the sound levels of the bass/middle/treble ranges of the sound sensed through the sound sensing unit with the reference sound levels of the bass/middle/treble ranges of the sound, correcting sound characteristics according to a result of comparison, and feeding the corrected sound characteristics back to the audio signal processing unit.

2. The apparatus as claimed in claim 1, wherein the sound sensing unit comprises a microphone.

3. The apparatus as claimed in claim 1, wherein the sound sensing unit is installed on a specified position of a front of the video display appliance.

4. The apparatus as claimed in claim 1, wherein the sound sensing unit measures the sound levels of the bass/middle/treble ranges of the sound that are output through the speaker, reflected according to the installation environment characteristics of the video display appliance, and then input to the sound sensing unit.

5. The apparatus as claimed in claim 1, wherein the control unit calculates a sound difference value between the sensed sound levels of the middle/bass ranges, and if the calculated sound difference value is not equal to a preset reference value, corrects the sound characteristics of the middle/bass ranges so that the sound difference value becomes equal to the preset reference value; and
wherein the control unit calculates a sound difference value between the sensed sound levels of the middle/treble ranges, and if the calculated sound difference value is not equal to a preset reference value, corrects the sound characteristics of the middle/treble ranges so that the sound difference value becomes equal to the preset reference value.

6. An apparatus for correcting sound for a video display appliance having a speaker for outputting the sound, the apparatus comprising:
a memory for storing reference values of sound differences between sound levels of middle/bass ranges of the sound and reference values of sound differences between sound levels of middle/treble ranges of the sound among the sound levels of the bass/middle/treble ranges of the sound preset according to installation environment characteristics of the video display appliance;
a sound sensing unit for sensing bass/middle/treble ranges of the sound output through the speaker, and
a control unit for calculating a sound difference value between the sound levels of the middle/bass ranges among the sound levels of the bass/middle/treble ranges of the sound sensed through the sound sensing unit, and if the calculated sound difference value is not equal to the preset reference value of the sound difference between the sound levels of the middle/bass ranges of the sound, correcting the sound characteristics of the middle/bass ranges so that the sound difference value between the sound levels of the middle/bass ranges becomes equal to the preset reference value, the control unit further calculating a sound difference value between the sound levels of the middle/treble ranges among the sound levels of the bass/middle/treble ranges of the sound, and if the calculated sound difference value is not equal to the preset reference value of the sound difference between the sound levels of the middle/treble ranges of the sound, correcting the sound characteristics of the middle/treble ranges so that the sound difference value between the sound levels of the middle/treble ranges becomes equal to the preset reference value.

7. The apparatus as claimed in claim 6, wherein the sound sensing unit comprises a microphone.

8. The apparatus as claimed in claim 6, wherein the sound sensing unit is installed on a specified position of a front of the video display appliance.

9. The apparatus as claimed in claim 6, wherein the sound sensing unit measures the sound levels of the bass/middle/treble ranges of the sound that are output through the speaker, reflected according to the installation environment characteristics of the video display appliance, and then input to the sound sensing unit.

10. A method for correcting sound for a video display appliance having a tuner for selecting a broadcasting signal, a demultiplexer for separating the received broadcasting signal into video and audio signals and a speaker for outputting the sound, the method comprising the steps of:
reproducing and outputting through the speaker bass/middle/treble range of the audio signal separated through the demultiplexer if a user inputs a ‘power-on’ command;
sensing the bass/middle/treble ranges of the sound output through the speaker; and
comparing sound levels of the sensed bass/middle/treble ranges of the sound with reference sound levels of the bass/middle/treble ranges of the sound stored in a memory and correcting sound characteristics of the output sound according to a result of comparison.

11. The method as claimed in claim 10, wherein the sound sensing step senses the sound using a microphone.

12. The method as claimed in claim 11, wherein the microphone is installed on a specified position of a front of the video display appliance.

13. The method as claimed in claim 10, wherein the sound sensing step measures the sound levels of the bass/middle/treble ranges of the sound that are output through the speaker, reflected according to the installation environment characteristics of the video display appliance, and then input to the sound sensing unit.

14. The method as claimed in claim 10, wherein the step of correcting the sound characteristics comprises the sub-steps of:
calculating a sound difference value between the sensed sound levels of the middle/bass ranges;
if the calculated sound difference value is not equal to a preset reference value, correcting the sound characteristics of the middle/bass ranges so that the sound difference value becomes equal to the preset reference value;
calculating a sound difference value between the sensed sound levels of the middle/treble ranges; and
if the calculated sound difference value is not equal to a preset reference value, correcting the sound characteristics of the middle/treble ranges so that the sound difference value becomes equal to the preset reference value.
